(19) United States
(12) Patent Application Publication
(10) Pub. No.: US 2024/0318907 A1
(43) Pub. Date: Sep. 26, 2024

(54) INTEGRATED REFRIGERATION SYSTEM OF A LIQUEFIED NATURAL GAS PRODUCTION PLANT COMPRISING A CARBON CAPTURE UNIT

(71) Applicant: NUOVO PIGNONE TECNOLOGIE - SRL, Florence (IT)

(72) Inventors: Olaf STALLMANN, Frankfurt (DE); Gianluca DI FEDERICO MANGIFESTA, Frankfurt (DE); Christoph WEINGAERTNER, Frankfurt (DE)

(21) Appl. No.: 18/578,188

(22) PCT Filed: Jul. 14, 2022
(86) PCT No.: PCT/EP2022/025329

§ 371 Date: Jan. 10, 2024

(30) Foreign Application Priority Data
Jul. 15, 2021 (IT) 102021000018731

(51) Int. Cl. F25J 1/00; B01D 53/14; F25J 1/02

(52) U.S. Cl. CPC F25J 1/0022; B01D 53/1475; F25J 1/0052; F25J 1/0087; F25J 1/0238; B01D 2252/102; F25J 2205/50

(57) ABSTRACT

A liquefied natural gas production plant comprising a carbon capture unit wherein the refrigerant fluid thermodynamic refrigeration cycle of the carbon capture system and the refrigerant fluid thermodynamic refrigeration cycle of the liquefied natural gas production plant are integrated by using the same refrigerant fluid and sharing at least some apparatuses, thus reducing the overall number of apparatuses and in particular the overall number of compressors and consequently reducing the emissions of carbon dioxide produced by the compressors.

### TECHNICAL FIELD

The present disclosure concerns a liquefied natural gas production plant comprising a carbon capture unit, with an integrated refrigeration system of a cooling unit of the liquefied natural gas production plant and a cooling unit of the carbon capture unit. Embodiments disclosed herein specifically concern a liquefied natural gas production plant wherein a liquefied natural gas cooling unit and the refrigerant system of a carbon capture unit are configured to limit the number of the overall components of the liquefied natural gas production plant.

### BACKGROUND ART

Natural gas is a naturally occurring hydrocarbon gas mixture comprising primarily of methane, but commonly including little amounts of other hydrocarbons, mainly light alkenes like propane and butane.

For practical and commercially viable transport of natural gas, its volume has to be greatly reduced. To do this, the gas must be liquefied by refrigeration to less than −161° C. (the boiling point of methane at atmospheric pressure). Each liquid natural gas production plant consists of one or more liquefaction and purification facilities to convert natural gas into liquefied natural gas.

The liquefaction process involves removal of certain components, such as dust, acid gases, water, mercury and heavy hydrocarbons, which could cause difficulty downstream. The natural gas is then condensed into a liquid with a vapor pressure close to atmospheric pressure by cooling it to approximately −162° C.; maximum transport pressure is set at around 25 kPa (4 psi).

In order to reduce the temperature of natural gas, the heat of the natural gas is transferred to a refrigerant fluid in controlled conditions through the use of heat exchangers. After having absorbed heat from the natural gas, in order to be reused the refrigerant fluid is conveniently cooled in a closed thermodynamic refrigeration cycle, wherein a cooling effect is produced through cyclic thermodynamic transformations, including compression, cooling, condensation, expansion and vaporization.

In order to reduce the irreversible heat exchange losses in the liquefaction process, several refrigeration cycles in which different refrigerants vaporize at different temperatures can be used. Additionally, it is possible to reduce the power required by the compressors by dividing each refrigeration cycle into several pressure stages, so that the work of refrigeration is split into different temperature steps.

In order to obtain the liquefaction of natural gas through heat exchange with one or more refrigerant fluids, efficiency of heat exchange is a key issue in order to save costs. To this aim, the components of the liquefied natural gas production plant are carefully designed. Nevertheless, an additional optimization of the liquefied natural gas production could be attained by the integration with external processes, allowing to reduce the overall installation and operation costs.

The need for a reduction of carbon dioxide emissions has become a major concern to avoid global warming. The accelerated increase of carbon dioxide concentration in the atmosphere is attributed to the growing use of fuels, such as coal, oil and gas, which release billions of tons of carbon dioxide to the atmosphere every year.

Many technologies have been developed allowing the decreasing of the emissions from industrial plants. Carbon dioxide capture implies separating the CO₂ from the rest of the flue gases from an industrial plant instead of releasing the CO₂ in the atmosphere. Several methods can be used to capture CO₂ from coal-fired plants. Post combustion techniques separate the carbon dioxide from the flue gas after a traditional combustion process. The main advantage of such technique is that the combustion at the power plant is unaltered, so the process can be implemented on existing power plants. A process using aqueous ammonia as solvent and operating at low temperature (2-10° C.), also known as Chilled ammonia carbon capture Process (CAP), has been developed and involves many advantages including: i) low cost and large availability of the solvent, ii) chemically stable solution, iii) high stability to oxygen, iv) regeneration at medium pressure and v) high CO₂ carrying capacity.

The use of chilled ammonia to capture carbon dioxide was disclosed in WO2006022885. First, the purpose of the process is to absorb the carbon dioxide at a low temperature, in particular at a temperature range from 0 to 20° C., and preferably from 0 to 10° C. Hence, after treating the flue gas in a reactor to remove contaminants, it is first cooled down in a plurality of heat exchangers. Then, the cooled flue gas enters a CO₂ capture section, composed by an absorber and a desorber. The flue gas enters the bottom of the absorber in countercurrent with a CO₂ lean stream, mainly composed of water and ammonia, and including little amount of carbon dioxide, entering the top of the absorber and coming from the bottom of the desorber. The carbon dioxide of the flue gas is absorbed by the ammonia in the absorber. A low temperature in the absorber prevents the ammonia from evaporating and enhances the mass transfer of CO₂ to the solution. According to WO2006022885, more than 90% of the CO₂ from the flue gas can be captured.

A cleaned gas stream leaves the absorber from its top, while a CO₂ rich stream leaves the bottom of the absorber and is sent by means of a pump to a heat exchanger where it is warmed, and then sent to the desorber. Inside the desorber CO₂ separates from the solution and leaves the top of the desorber as a relatively clean and high pressure stream. A condenser is provided at the top of the desorber to separate water vapor and ammonia contained in the CO₂ stream and recirculate them to the desorber. A CO₂ lean stream leaves the bottom of the desorber and is routed to an air cooler and subsequently to the top of the absorber, to absorb CO₂ from the flue gas. The desorption reaction is endothermic, the energy that has to be supplied highly depending on the composition of the CO₂ rich stream that enters the desorber.

A carbon capture unit can be conveniently associated to a liquefied natural gas production plant in order to reduce emissions of carbon dioxide produced by the compressor's driver, usually a gas turbine, used in the thermodynamic refrigeration cycle. In case of electrical compressor drives the carbon capture unit can be applied to the related power generation facility. Applying such a carbon capture unit to current small and mid-scale liquefied natural gas production plants requires the installation of a dedicated refrigeration cycle, comprising apparatuses like compressors and heat exchangers.

Accordingly, an optimized liquefied natural gas production plant aiming at reducing emissions of carbon dioxide and limiting the increase in the total number of apparatuses would be beneficial and would be welcomed in the technology.

### SUMMARY

In one aspect, the subject matter disclosed herein is directed to a liquefied natural gas production plant comprising a carbon capture unit wherein an integrated refrigerant system is used, wherein the integration consists in using the same thermodynamic refrigeration cycle system both in the cooling of the natural gas and in the cooling of the solvent in the carbon capture unit, with the result of a reduction of the overall components of the integrated system compared to the components of two separate refrigeration units.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a process flow diagram of a liquefied natural gas production plant according to the prior art;

FIG. 2 illustrates a process flow diagram of a chilled ammonia carbon capture system according to the prior art;

FIG. 3 illustrates a process flow diagram of a chilled ammonia carbon capture system's refrigerant fluid refrigeration cycle according to the prior art; and

FIG. 4 illustrates a process flow diagram of an optimized liquefied natural gas production plant comprising a carbon capture unit, with an integrated refrigeration system of a pre-cooling unit of the liquefied natural gas production plant and of the carbon capture unit, according to an exemplary embodiment.

### DETAILED DESCRIPTION OF EMBODIMENTS

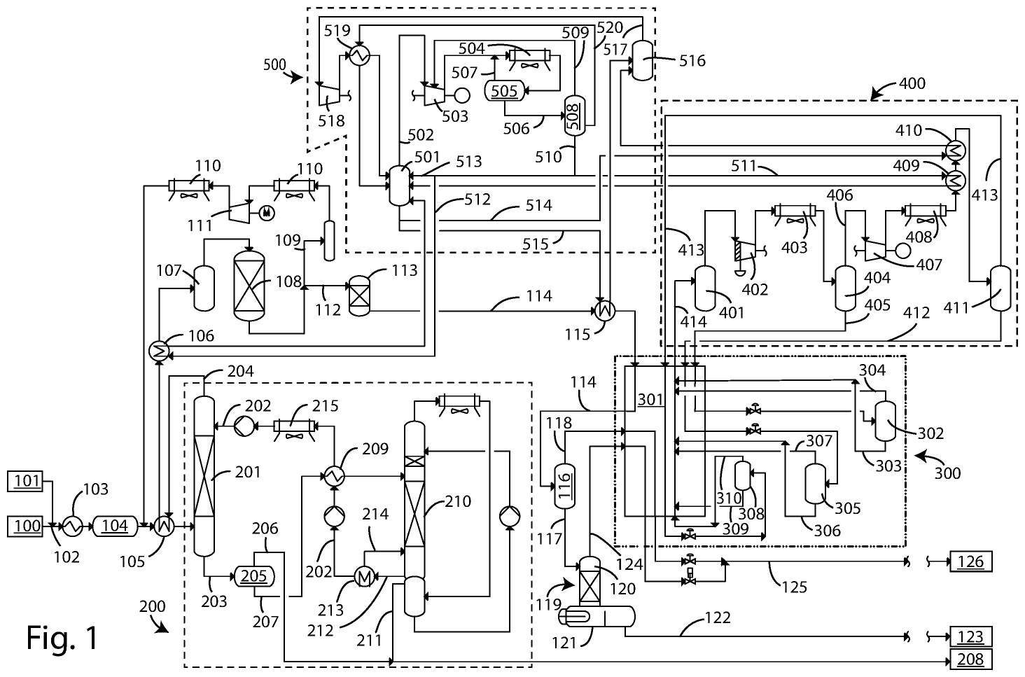

According to an exemplary prior art, a liquefied natural gas production plant comprises a natural gas inlet 100 and a boil off gas inlet 101, routing to an inlet stream line 102 and to a heat exchanger 103, wherein the inlet stream is cooled before being routed to a separator 104. The stream from the separator 104 is cooled in a heat exchanger 105, and is routed to a pre-treatment unit 200, wherein CO₂, together with H₂S, is removed from the natural gas stream 102. According to the exemplary prior art shown in FIG. 1, the CO₂ removal pre-treatment unit 200 comprises a contactor column 201, wherein an amine solvent stream 202 from the top of the contactor column 201 chemically absorbs H₂S, CO₂ and exits from the bottom of the contactor column 201 as a bottom stream 203, while the natural gas stream 204 exits from the top of the contactor column 201. The bottom stream 202 is routed to a flash drum 205, wherein a gas stream 206, comprising H₂S and CO₂ is separated from a liquid stream 207 of concentrated amine, also comprising little amounts of contaminants. The gas stream 206 is routed to an incinerator or flare 208, while the liquid stream 207 is sent to a heat exchanger 209 to be heated before entering an amine regenerator 210, wherein a stream of contaminants 211 is separated and routed to the incinerator or flare 208, while a regenerated amine stream 212 is heated in a heat exchanger 213 and partly separated into a recycled stream 214, routed back to the amine regenerator 210, while the rest of the regenerated amine stream 212 is cooled by providing heat to the liquid stream 207 of concentrated amine in the heat exchanger 209 and additionally cooled in a fan cooler 215 before returning to the top of the contactor column 201 as an amine solvent stream 202.

The partly treated natural gas stream 204 from the top of the contactor column 201 exchanges heat with the natural gas stream 102 entering the contactor column 201 and is subsequently cooled in a heat exchanger 106 and routed to a drier knock-out drum 107 and to a drier 108. Part of the dried natural gas is recycled, as a recycle stream 109, to the natural gas stream 102 upstream the CO₂ removal pre-treatment unit 200, the recycle stream 109 being cooled in fan coolers 110 and compressed in a compressor 111. The main dried natural gas stream 112 is routed to a mercury removal unit 113.

The pre-treated natural gas stream 114 is then cooled in a heat exchanger 115 and in a cold box 300, and subsequently routed to a separator 116.

The cold box 300 comprises a plurality of heat exchangers, indicated as a whole as a heat exchanger 301, for thermal exchange between the process streams of the liquefied natural gas production plant and a refrigerant fluid. According to an exemplary refrigeration technology of the prior art, the refrigerant fluid can be conveniently composed of two or more components, and is consequently named a “mixed refrigerant”, is cooled in a closed thermodynamic refrigeration cycle system 400, wherein a cooling effect is produced through cyclic thermodynamic transformations of the refrigerant fluid, including compression, cooling, condensation, expansion and vaporization.

Making reference to FIG. 1, according to an exemplary refrigeration technology of the prior art that can also be used in the liquefied natural gas production plant of the invention, the refrigerant fluid from a collector 401 is compressed in a compressor 402 and subsequently cooled in a fan cooler 403, wherein the heaviest fractions of the refrigerant condense. The cooled refrigerant stream is then routed to a separator 404, wherein it is separated into a liquid stream 405 and a vapor stream 406. The liquid stream 405 is directed to the heat exchanger 301 of the cold box 300, wherein it absorbs heat and is partly vaporized. The partly vaporized stream is then sent to a separator 302 of the cold box 300, wherein it is separated into a liquid stream 303 and a vapor stream 304. Both the liquid stream 303 and the vapor stream 304 are routed to the heat exchanger 301 of the cold box 300, to absorb heat before being mixed together in a stream 414 and directed to the collector 401 of the closed thermodynamic refrigeration cycle system 400.

The vapor stream 406 from the separator 404 of the closed thermodynamic refrigeration cycle system 400 is sent to a second compressor 407 and subsequently cooled in a fan cooler 408, a first heat exchanger 409 and a second heat exchanger 410, wherein other fractions of the refrigerant condense. The cooled refrigerant stream is then routed to a separator 411, wherein it is separated into a liquid stream 412 and a vapor stream 413, the vapor stream 413 being composed of the lightest fractions of the refrigerant. The liquid stream 412 is directed to the heat exchanger 301 of the cold box 300, wherein it absorbs heat and is partly vaporized. The partly vaporized stream is then sent to a separator 305 of the cold box 300, wherein it is separated into a liquid stream 306 and a vapor stream 307. Both the liquid stream 306 and the vapor stream 307 are routed to the heat exchanger 301, to absorb heat before being mixed together in the stream 414 and directed to the collector 401 of the closed thermodynamic refrigeration cycle system 400.

The vapor stream 413 from the separator 411 of the closed thermodynamic refrigeration cycle system 400 is directed to the cold end of the heat exchanger 301 of the cold box 300, wherein it is cooled and partly condensed. The partly condensed stream is then sent to a separator 308 of the cold box 300, wherein it is separated into a liquid stream 309 and a vapor stream 310. Both the liquid stream 309 and the vapor stream 310 are routed to the heat exchanger 301, to absorb heat before being mixed together in the stream 414 and directed to the collector 401 of the closed thermodynamic refrigeration cycle system 400.

On the natural gas side of the liquefied natural gas production plant, after being cooled in the heat exchanger 301 of the cold box 300, in order to condense heavier than methane hydrocarbons, the natural gas stream 114 is routed to the separator 116, wherein it is separated into a liquid stream 117 and a vapor stream 118, the liquid stream 117 comprising heavier than methane hydrocarbons, together with a certain amount of methane. From the top of the separator 116, the vapor stream 118 is routed to the heat exchanger 301, to be cooled at a temperature causing the condensation of the vapor.

The liquid stream 117 comprising heavier than methane hydrocarbons is routed to a debutanizer 119, to separate methane still present in the liquid stream 117, from heavier than methane hydrocarbons, in particular from butane. The debutanizer 119, being composed of a pressurized column 120 with a boiler 121 at its bottom, provides heat to the liquid stream, vaporizing the lighter components of the liquid stream, mainly methane with a little amount of propane and some butane, which run through the column 120, wherein a vapor-liquid equilibrium is established between components with different boiling points. A liquid stream 122 from the boiler 121 of the debutanizer 119, comprised mainly of butane, but also comprising propane and heavier than butane components, is obtained and is routed to a liquid petroleum gas collection unit 123. A vaporized stream 124 from the top of the debutanizer 119, mainly comprising methane, is sent to the heat exchanger 301 of the cold box 300, wherein it is condensed and subsequently mixed with the condensed vapor stream 118, a liquefied natural gas stream 125, sent to a liquefied natural gas stream collection unit 126.

The exemplary prior art liquefied natural gas production unit of FIG. 1 finally comprises an additional closed thermodynamic refrigeration cycle 500, configured to cool a refrigeration fluid used to pre-cool the natural gas stream in the heat exchangers 106 and 115 and the mixed refrigerant of the closed thermodynamic refrigeration cycle system 400, in the heat exchangers 409 and 410.

According to the exemplary prior art refrigeration technology of FIG. 1, the refrigerant fluid of the additional closed thermodynamic refrigeration cycle 500 is preferably ammonia and its cooling is obtained through cyclic thermodynamic transformations including compression, cooling, condensation, expansion and vaporization.

In particular, making reference to FIG. 1, according to an exemplary refrigeration technology of the prior art that can also be used in the liquefied natural gas production plant of the invention, ammonia is used as refrigerant. Ammonia refrigerant is collected in a collector 501 at a temperature of 12° C. and a pressure of 6.5 bar. Under these conditions, the ammonia refrigerant separates into a vapor fraction and a liquid fraction. The vapor fraction exits the collector 501 as a vapor stream 502 and is compressed in a compressor 503 and subsequently cooled in a fan cooler 504, wherein the heaviest fractions of the refrigerant condense. The cooled refrigerant stream is then routed to a first separator 505, at a temperature of 38° C. and a pressure of 14.7 bar wherein it is separated into a liquid stream 506 and a vapor stream 507. The liquid stream 506 is directed to a second separator 508, at a temperature of 20° C. and a pressure of 8.5 bar, while the vapor stream 507 is recycled to the fan cooler 504.

At the conditions of the second separator 508 the ammonia refrigerant separates into a vapor fraction and a liquid fraction. The vapor fraction exits from the second separator 508 as a vapor stream 509 and is recycled to the compressor 503. The liquid fraction exits from the second separator 508 as a liquid stream 510 that is divided into a first sub-stream 511, used to lower the temperature of the mixed refrigerant in the heat exchanger 409, before being directed to the collector 501, a second sub-stream 512, used to lower the temperature of the natural gas stream 204 in the heat exchanger 106, before being directed to the collector 501, and a third sub-stream, directly routed to the collector 501.

The liquid fraction of the collector 501 exits the collector as a liquid stream, which is divided into a first sub-stream 514, used to lower the temperature of the mixed refrigerant in the heat exchanger 410, before being directed to a collector 516, and a second sub-stream 515, used to lower the temperature of the natural gas stream in the heat exchanger 115, before being directed to the collector 516. The collector 516 operating at a pressure of 2.6 bar, the liquid ammonia refrigerant evaporates, thus lowering its temperature down to −11° C. A vapor stream 517 directs the vapor ammonia refrigerant to a compressor 518 and subsequently to a heat exchanger 519, where it is cooled by exchanging heat with a liquid stream 520 from the separator 508, before being directed to the collector 501. The liquid stream 520 from the separator 508 is also directed to the collector 501.

In the refrigeration technology of the exemplary prior art referred to in FIG. 1, the refrigerant fluid is ammonia. However, the same refrigeration technology applies in case a different refrigerant fluid is used, such as for example propylene or propane. More advanced schemes may even use a mixture of hydrocarbons having 2, 3, 4 or even 5 carbon atoms per molecule. For example, a mixture of propane, iso-pentane and small amounts of ethylene is expected to provide superior performance with regards to refrigerant compressor power consumption. Nevertheless, propylene, butane and to a certain extend also pentane are also considered potential constituents in a suitable refrigerant mixture. It is clear to those skilled in the art, that application of different refrigerants would result in slightly different operating conditions in the refrigeration loop in order to maintain the targeted cooling level temperatures.

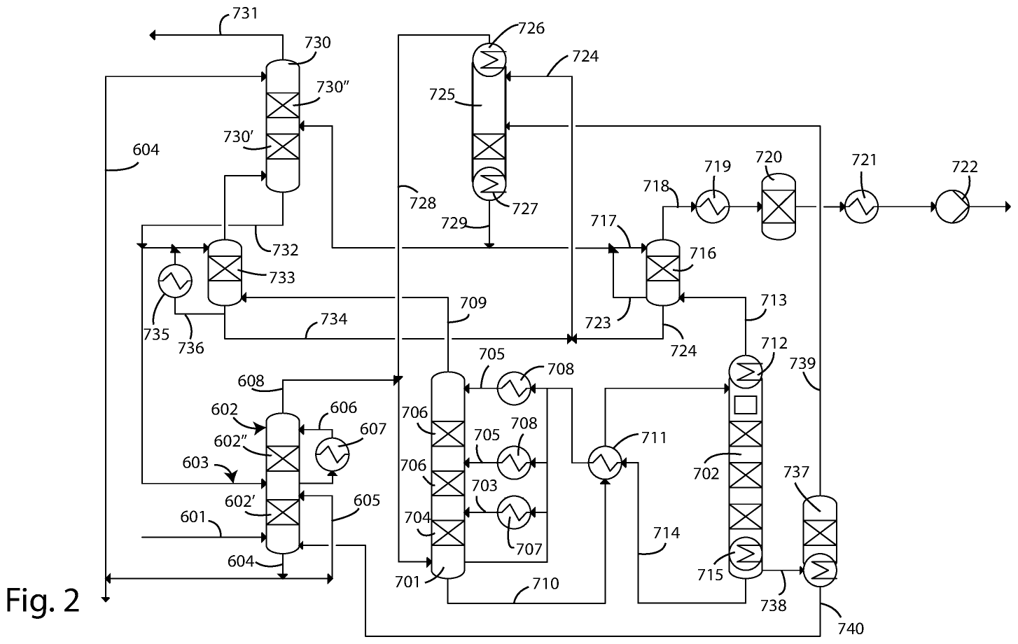

Making reference to FIG. 2, it is shown a process flow diagram of a chilled ammonia carbon capture system according to the prior art. The system is intended to remove carbon dioxide from a flue gas stream 601 and comprises an absorber 602, the absorber comprising a lower section 602′ wherein the flue gas is contacted in countercurrent with a stream 603 of an aqueous ammonia solution to remove contaminants, namely sulfates, through absorption. An ammonium sulfate solution exits the bottom of the absorber 602 as a liquid stream 604, which is partly recycled as a liquid stream 605 to the absorber 602, above the lower section 602′. The absorber also comprises an upper portion 602″, wherein the flue gas from the lower section 602′ is contacted in countercurrent with a stream 606 collected below the upper section 602″ and directed to the top of the absorber 602, after being cooled in a heat exchanger 607, wherein the stream 606 exchanges heat with a refrigerant fluid at a temperature of 2° C. The flue gas stream 608 from the top of the absorber 602 is directed to a CO₂ capture section 700, composed by an absorber 701 and a desorber 702 operating under high pressure (typically 21 bar). The flue gas stream 608 enters the bottom of the absorber 701 in countercurrent with a first CO₂ lean stream 703, entering the absorber 701 above a first section 704, and with a second and a third CO₂ lean streams 705, entering the absorber 701 above a second and a third sections 706, the CO₂ lean streams 703, 704 being mainly composed of water and ammonia, and including little amount of carbon dioxide and coming from the bottom of the desorber 702. Before entering the absorber 701, the CO₂ lean stream 703 is cooled in a heat exchanger 707, wherein the stream 703 exchanges heat with a refrigerant fluid at a temperature of 17° C., whereas the CO₂ lean streams 704 are cooled in heat exchangers 708, wherein the streams 704 exchange heat with a refrigerant fluid at a temperature of 2° C. Inside the absorber 701, the carbon dioxide of the flue gas is absorbed by the ammonia of the CO₂ lean streams 703, 704. A low temperature in the absorber 701 prevents the ammonia from evaporating and enhances the mass transfer of CO₂ to the solution.

A cleaned flue gas stream 709 leaves the absorber 701 from its top, while a CO₂ rich stream 710 leaves the bottom of the absorber 701 and is routed by means of a pump to a heat exchanger 711 where it is warmed, and then to the upper part of the desorber 702. A condenser 712 is provided at the top of the desorber 702 to separate water vapor and ammonia from CO₂ and recirculate them to the desorber. CO₂ leaves the desorber 702 from its top as a relatively clean and high pressure CO₂ stream 713. A CO₂ lean stream 714 leaves the bottom of the desorber 702 and is routed to the absorber 701, after exchanging heat in the heat exchanger 711 with the CO₂ rich stream 710 from the bottom of the absorber 701. The desorption reaction being endothermic, heat is provided at the bottom of the desorber 702 through a heater 715.

The CO₂ stream 713 is routed to a CO₂ wash column 716, wherein it is contacted in countercurrent with a stream 717 of an aqueous ammonia solution to remove residual gases, through absorption. The CO₂ stream 718 from the top of the CO₂ wash column 716 is then cooled in heat exchanger 719, wherein the stream 718 exchanges heat with a refrigerant fluid at a temperature of 12° C. and water condenses and is removed from the stream 718. The CO₂ stream 718 is additionally dried in a dryer 720 and cooled in heat exchanger 721, wherein the stream 718 exchanges heat with a refrigerant fluid at a temperature of −25° C. to obtain liquefaction of the CO₂ and finally collected as a pure CO₂ liquid stream 722.

The aqueous ammonia solution from the bottom of the wash column 716 is partially recycled to the top of the wash column 716 as a recycle stream 723 and partially routed as a stream 724 to a NH₃ stripping column 725, provided with a condenser 726 at the top and with a heater 727 at the bottom. The NH₃ stripping column 725 separates residual gases from the aqueous ammonia solution. The residual gases from the top of the stripping column 725 are routed to the bottom of the absorber 701, as a gas stream 728. The aqueous ammonia solution stream 729 from the bottom of the stripping column 725 is partly routed to the CO₂ wash column 716, and partly directed to an absorber 720, to remove residual CO₂ from the flue gas stream 709 coming from the absorber 701.

The absorber 720 comprises a lower section 720′ wherein the flue gas is contacted in countercurrent with the aqueous ammonia solution stream 729 and an upper section 720″ wherein the flue gas is contacted in countercurrent with the liquid stream 604 from the bottom of the absorber 602. A clean flue gas stream 731 is obtained from the top of the absorber 720. An aqueous ammonia solution stream 732 from the bottom of the absorber 720 is partly routed to the absorber 602 and partly to the upper part of a flue gas wash column 733, to separate residual water from the clean flue gas stream 709 upstream the absorber 730. An aqueous ammonia solution stream 734 exits from the bottom of the flue gas wash column 733 and is partly directed to the stripping column 725, after mixing with the stream 724 from the bottom of the CO₂ wash column 716, and partly cooled down in a heat exchanger 735, wherein the stream 736 from the bottom of the flue gas wash column 733 exchanges heat with a refrigerant fluid at a temperature of 2° C.

Finally, the system comprises a stripper 737, wherein an aqueous ammonia solution stream 728 from the bottom of the desorber 702 separates into a vapor stream 739, which is directed to the NH₃ stripping column 725 and a liquid stream 740, which is directed to the bottom of the absorber 602.

The refrigerant fluid exchanging heat with process fluids in the exchangers 607, 707, 708, 719, 721 and 735 can be for example anhydrous ammonia, propylene, propane or a suitable mixture of refrigerants as described above. In order to exchange heat at different temperatures and in order to be reused after having absorbed heat from the process streams, the refrigerant fluid is conveniently cooled in a closed thermodynamic refrigeration cycle, wherein a cooling effect is produced through cyclic thermodynamic transformations, including compression, cooling, condensation, expansion and vaporization.

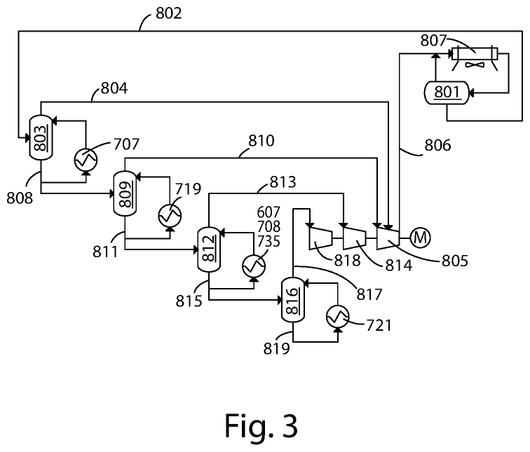

In particular, referring to FIG. 3, ammonia is used as the refrigerant fluid and the refrigeration cycle comprises a collector 801, where the refrigerant fluid is collected at a temperature of 38° C. and a pressure of 14.7 bar. A refrigerant fluid liquid stream 802 is routed from the collector 801 to a first separator 803, at a pressure of 7.7 bar, wherein the refrigerant fluid separates into a liquid fraction and a vapor fraction at a temperature of 17° C. The vapor fraction is directed as a vapor stream 804 to a compressor 805 and subsequently as a compressed stream 806, to a fan cooler 807 and subsequently to the collector 801. The liquid fraction exits the separator 803 as a liquid stream 808 at a temperature of 17° C., which is partly directed to the heat exchanger 707 of the absorber 701 of the chilled ammonia carbon capture system of FIG. 2 and then back to the upper part of the separator 803 and partly to a second separator 809.

Inside the second separator 809, at a pressure of 6.5 bar, the refrigerant fluid separates into a liquid fraction and a vapor fraction at a temperature of 12° C. The vapor fraction is directed as a vapor stream 810 to the compressor 805 and subsequently as a compressed stream 806, to the fan cooler 807 and subsequently to the collector 801. The liquid fraction exits the separator 809 as a liquid stream 811 at a temperature of 12° C., and is partly directed to the heat exchanger 719 of the CO₂ stream 718 from the top of the CO₂ wash column 716 of the chilled ammonia carbon capture system of FIG. 2 and then back to the upper part of the separator 809, and partly to a third separator 812.

Inside the third separator 812, at a pressure of 4.5 bar, the refrigerant fluid separates into a liquid fraction and a vapor fraction at a temperature of 2° C. The vapor fraction is directed as a vapor stream 813 to a compressor 814, then to the compressor 805 and subsequently as a compressed stream 806, to the fan cooler 807 and to the collector 801. The liquid fraction exits the separator 812 as a liquid stream 815 at a temperature of 2° C., and is partly directed to the heat exchangers 607, 708, 735 of the chilled ammonia carbon capture system of FIG. 2 and then back to the upper part of the separator 812, and partly to a fourth separator 816.

Finally, inside the fourth separator 816, at a pressure of 1.8 bar, the refrigerant fluid separates into a liquid fraction and a vapor fraction at a temperature of −25° C. The vapor fraction is directed as a vapor stream 817 to a compressor 818, then to the compressor 814 and to the compressor 805 and subsequently as a compressed stream 806, to the fan cooler 807 and to the collector 801. The liquid fraction exits the separator 816 as a liquid stream 819 at a temperature of −25° C., and is directed to the heat exchanger 721 of the CO₂ stream downstream the drier 720 of the chilled ammonia carbon capture system of FIG. 2 and then back to the upper part of the separator 816.

According to one aspect, the present subject matter is directed to the combination of a refrigerant fluid thermodynamic refrigeration cycle of a chilled ammonia carbon capture system with a refrigerant fluid thermodynamic refrigeration cycle of a liquefied natural gas production plant. In order to combine the two thermodynamic refrigeration cycles, the same refrigerant fluid must be used. As a result, the same compressors can be used under the two thermodynamic refrigeration cycles, thus reducing the overall number of apparatuses and in particular the overall number of compressors and consequently reducing the emissions of carbon dioxide produced by the compressors.

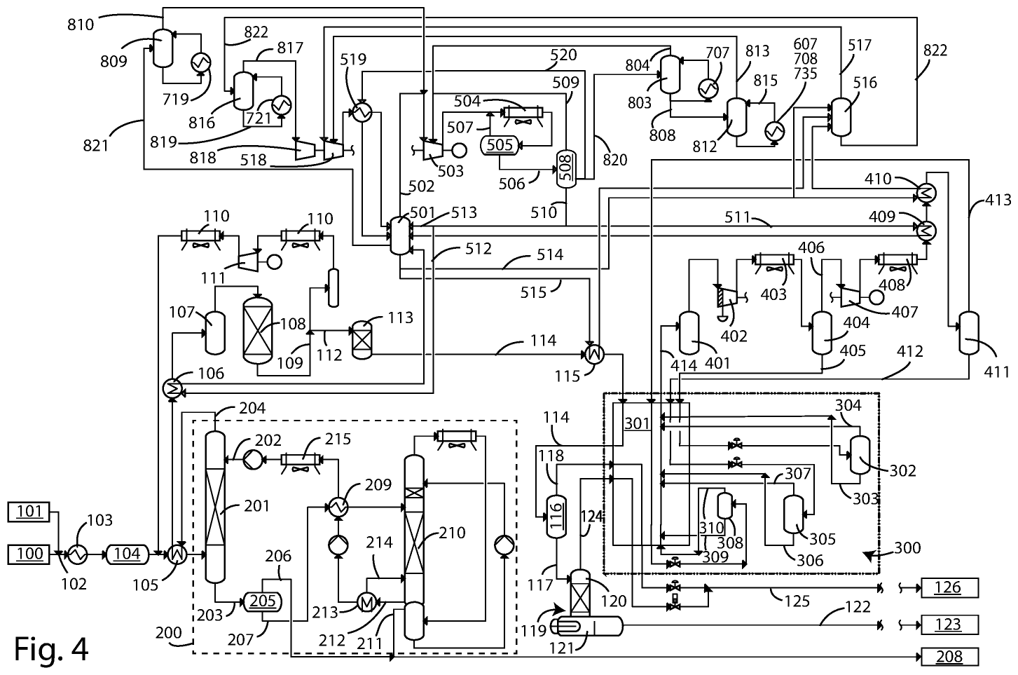

Reference now will be made in detail to one embodiments of the disclosure, which is illustrated in FIG. 4 by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When introducing elements of various embodiments, the articles “a”, “an”, “the”, and “said” are intended to mean that there are one or more of the elements. The terms “comprising”, “including”, and “having” are intended to be inclusive and mean that there may be additional elements other than the listed elements.

Referring to FIG. 4, it is shown a process flow diagram of a liquefied natural gas production plant comprising a carbon capture unit, with an integrated refrigeration system of a pre-cooling unit of the liquefied natural gas production plant and of the carbon capture unit.

As already disclosed with reference to FIG. 1, and using the same reference number to indicate the same elements, an exemplary liquefied natural gas production system according to the present subject matter comprises an inlet stream 102, fed by a natural gas inlet 100 and/or a boil off gas inlet 101, a heat exchanger 103, wherein the inlet stream 102 is cooled before being routed to a separator 104 and then to a heat exchanger 105, wherein it is cooled down before being routed to a pre-treatment unit 200. Inside the pre-treatment unit 200, CO₂ and H₂S are removed from the natural gas stream 102. According to an exemplary embodiment, the CO₂ removal pre-treatment unit 200 comprises a contactor column 201, wherein an amine solvent stream 202 from the top of the contactor column 201 chemically absorbs H₂S and CO₂ and exits from the bottom of the contactor column 201 as a bottom stream 203, while the natural gas stream 204 exits from the top of the contactor column 201. The bottom stream 202 is routed to a flash drum 205, wherein a gas stream 206, comprising H₂S and CO₂ is separated from a liquid stream 207 of concentrated amine, also comprising little amounts of contaminants. The gas stream 206 is routed to an incinerator or flare 208, while the liquid stream 207 is sent to a heat exchanger 209 to be heated before entering an amine regenerator 210, wherein a stream of contaminants 211 is separated and routed to the incinerator or flare 208, while a regenerated amine stream 212 is heated in a heat exchanger 213 and partly separated into a recycled stream 214, routed back to the amine regenerator 210, while the rest of the regenerated amine stream 212 is cooled by providing heat to the liquid stream 207 of concentrated amine in the heat exchanger 209 and additionally cooled in a fan cooler 215 before returning to the top of the contactor column 201 as an amine solvent stream 202.

The pre-treatment unit 200 of FIG. 4 represent a suitable technology for CO₂ removal according to the preset subject matter, shown as an exemplary technology. Alternatively, the pre-treatment unit 200 can use a different technology to remove CO₂ from the natural gas stream, such as different chemical solvents, physical solvents, molecular sieves, membranes, depending on the quantity of contaminants in the natural gas stream, the most suitable processes for CO₂ removal from pipeline-quality feed gas being chemical solvents and molecular sieves (molecular sieve only if initial CO₂ level is low enough).

The partly treated natural gas stream 204 from the top of the contactor column 201 exchanges heat with the natural gas stream 102 entering the contactor column 201 and is subsequently cooled in a heat exchanger 106, wherein it exchanges heat with a refrigerant fluid stream 512 at a temperature of 17° C. from a separator 508 of a refrigerant fluid thermodynamic refrigeration cycle. The partly treated natural gas stream 204 is subsequently routed to a drier knock-out drum 107 and to a drier 108. Part of the dried natural gas is recycled, as a recycle stream 109, to the natural gas stream 102 upstream the CO₂ removal pre-treatment unit 200, the recycle stream 109 being cooled in fan coolers 110 and compressed in a compressor 111. The main dried natural gas stream 112 is routed to a mercury removal unit 113.

The technology of drier knock-out drum 107, the drier 108 and the mercury removal unit 113 represent an exemplary embodiment of the present subject matter and can be chosen amongst the different technologies available according to the prior art. Additionally, the arrangement of the drier knock-out drum 107, the drier 108 and the mercury removal unit 113 of FIG. 4 represents a suitable plant arrangement according to the prior art, shown as an exemplary technology. Alternatively, the mercury removal unit 113 can be positioned upstream of the drier knock-out drum 107 and the drier 108. The mercury removal unit 113 can also be positioned upstream of the CO₂ removal pre-treatment unit 200, depending on different conditions, including lifecycle costs, adsorbent disposal methods, mercury levels, environmental limits.

The pre-treated natural gas stream 114 is then cooled in a heat exchanger 115, wherein it exchanges heat with a refrigerant fluid stream 515 at a temperature of 12° C., from a collector 501 of a refrigerant fluid thermodynamic refrigeration cycle. The pre-treated natural gas stream 114 is additionally cooled in a cold box 300, and subsequently routed to a separator 116.

The cold box 300 comprises a plurality of heat exchangers, indicated as a whole as a heat exchanger 301, for thermal exchange between the process streams of the liquefied natural gas production plant and a refrigerant fluid. According to an exemplary refrigeration technology, the refrigerant fluid can be conveniently composed of two or more components, and is consequently named a “mixed refrigerant”. The refrigerant fluid is cooled in a closed thermodynamic refrigeration cycle system 400, wherein a cooling effect is produced through cyclic thermodynamic transformations of the refrigerant fluid, including compression, cooling, condensation, expansion and vaporization.

According to an exemplary embodiment, the refrigerant fluid from a collector 401 is compressed in a compressor 402 and subsequently cooled in a fan cooler 403, wherein the heaviest fractions of the refrigerant fluid condensate. The cooled refrigerant stream is then routed to a separator 404, wherein it separates into a liquid stream 405 and a vapor stream 406. The liquid stream 405 is directed to the heat exchanger 301 of the cold box 300, wherein it absorbs heat and is partly vaporized. The partly vaporized stream is then sent to a separator 302 of the cold box 300, wherein it is separated into a liquid stream 303 and a vapor stream 304. Both the liquid stream 303 and the vapor stream 304 are routed to the heat exchanger 301 of the cold box 300, to absorb heat before being mixed together in a stream 414 and directed to the collector 401 of the closed thermodynamic refrigeration cycle system 400.

The vapor stream 406 from the separator 404 of the closed thermodynamic refrigeration cycle system 400 is sent to a second compressor 407 and subsequently cooled in a fan cooler 408. The stream 406 is additionally cooled in a heat exchanger 409, wherein it exchanges heat with a refrigerant fluid stream 511 at a temperature of 17° C., coming from a separator 508 of a refrigerant fluid thermodynamic refrigeration cycle and subsequently in a heat exchanger 410, wherein it exchanges heat with a refrigerant fluid stream 514 at a temperature of 12° C., coming from a collector 501 of a refrigerant fluid thermodynamic refrigeration cycle and wherein other fractions of the refrigerant condense. The cooled refrigerant stream is then routed to a separator 411, wherein it is separated into a liquid stream 412 and a vapor stream 413, the vapor stream 413 being composed of the lightest fractions of the refrigerant. The liquid stream 412 is directed to the heat exchanger 301 of the cold box 300, wherein it absorbs heat and is partly vaporized. The partly vaporized stream is then sent to a separator 305 of the cold box 300, wherein it is separated into a liquid stream 306 and a vapor stream 307. Both the liquid stream 306 and the vapor stream 307 are routed to the heat exchanger 301, to absorb heat before being mixed together in the stream 414 and directed to the collector 401 of the closed thermodynamic refrigeration cycle system 400.

The vapor stream 413 from the separator 411 of the closed thermodynamic refrigeration cycle system 400 is directed to the cold end of the heat exchanger 301 of the cold box 300, wherein it is cooled and partly condensed. The partly condensed stream is then sent to a separator 308 of the cold box 300, wherein it is separated into a liquid stream 309 and a vapor stream 310. Both the liquid stream 309 and the vapor stream 310 are routed to the heat exchanger 301, to absorb heat before being mixed together in the stream 414 and directed to the collector 401 of the closed thermodynamic refrigeration cycle system 400.

The mixed refrigerant cycle allows to exchange heat with the natural gas in a plurality of heat exchangers at different temperatures, taking advantage of the vaporization temperature difference between the different generated refrigerant streams to optimize the natural gas liquefaction by approaching the cooling curve of the natural gas from ambient to cryogenic temperatures, minimizing energy requirements and heat exchangers size.

On the natural gas side of the liquefied natural gas production plant, after being cooled in the heat exchanger 301 of the cold box 300, in order to condense heavier than methane hydrocarbons, the natural gas stream 114 is routed to the separator 116, wherein it is separated into a liquid stream 117 and a vapor stream 118, the liquid stream 117 comprising heavier than methane hydrocarbons, together with a certain amount of methane. From the top of the separator 116, the vapor stream 118 is routed to the heat exchanger 301, to be cooled at a temperature causing the condensation of the vapor.

The liquid stream 117 comprising heavier than methane hydrocarbons is routed to a debutanizer 119, to separate methane still present in the liquid stream 117, from heavier than methane hydrocarbons, in particular from butane. The debutanizer 119, being composed of a pressurized column 120 with a boiler 121 at its bottom, provides heat to the liquid stream, vaporizing the lighter components of the liquid stream, mainly methane with a little amount of propane and some butane, which run through the column 120, wherein a vapor-liquid equilibrium is established between components with different boiling points. A liquid stream 122 from the boiler 121 of the debutanizer 119, comprised mainly of butane, but also comprising propane and heavier than butane components, is obtained and is routed to a liquid petroleum gas collection unit 123. A vaporized stream 124 from the top of the debutanizer 119, mainly comprising methane, is sent to the heat exchanger 301 of the cold box 300, wherein it is condensed and subsequently mixed with the condensed vapor stream 118, a liquefied natural gas stream 125, sent to a liquefied natural gas stream collection unit 126.

The refrigerant fluid thermodynamic refrigeration cycle 500 of the liquefied natural gas production unit of the exemplary embodiment shown in FIG. 4, according to which ammonia is used as refrigerant comprises a collector 501 at a pressure of 6.5 bar. Under these conditions, the ammonia refrigerant cools down to a temperature of 12° C. and separates into a vapor fraction and a liquid fraction. The vapor fraction exits the collector 501 as a vapor stream 502 and is compressed in a compressor 503, thereby increasing its temperature. The stream 502 is subsequently cooled in a fan cooler 504, wherein the heaviest fractions of the refrigerant condense. The cooled refrigerant stream is then routed to a first separator 505, at a pressure of 14.7 bar wherein it cools down to a temperature of 38° C. and separates into a liquid stream 506 and a vapor stream 507. The liquid stream 506 is directed to a second separator 508, at a pressure of 8.5 bar, while the vapor stream 507 is recycled to the fan cooler 504.

At the pressure of the second separator 508 the ammonia refrigerant cools down to a temperature of 17° C. and separates into a vapor fraction and a liquid fraction. The vapor fraction exits from the second separator 508 as a vapor stream 509 and is recycled to the compressor 503. The liquid fraction exits from the second separator 508 as a liquid stream 510 that is divided into a first sub-stream 511, used to lower the temperature of the mixed refrigerant in the heat exchanger 409, before being directed to the collector 501, a second sub-stream 512, used to lower the temperature of the natural gas stream 204 in the heat exchanger 106, before being directed to the collector 501, and a third sub-stream, directly routed to the collector 501.

The liquid fraction of the collector 501 exits the collector as a liquid stream, which is divided into a first sub-stream 514, used to lower the temperature of the mixed refrigerant in the heat exchanger 410, before being directed to a collector 516, and a second sub-stream 515, used to lower the temperature of the natural gas stream in the heat exchanger 115, before being directed to the collector 516. The collector 516 operating at a pressure of 2.6 bar, the liquid ammonia refrigerant cooling down to a temperature of −11° C. and separating into a vapor fraction and a liquid fraction. The vapor fraction exits from the collector 516 as a vapor stream 517 and is routed to a compressor 518 and subsequently to a heat exchanger 519, where it is cooled by exchanging heat with a liquid stream 520 from the separator 508, before being directed to the collector 501. After exchanging heat with vapor stream 517 in the heat exchanger 519, the liquid stream 520 is directed to the collector 501.

According to an exemplary embodiment, a refrigerant fluid thermodynamic refrigeration cycle of a chilled ammonia carbon capture system is combined with the refrigerant fluid thermodynamic refrigeration cycle of a liquefied natural gas production. In particular, the liquid fraction of the separator 508, at a temperature of 17° C., is suitable to be used to exchange heat with the CO₂ lean stream 703, entering the absorber 701 of the chilled ammonia carbon capture system above a first section 704. Part of the liquid fraction of the separator 508 is therefore directed, as a liquid ammonia stream 820, to a separator 803, at a pressure of 7.7 bar, wherein the refrigerant fluid separates into a liquid fraction and a vapor fraction at a temperature of 17° C. The vapor fraction is directed as a vapor stream 804 to the compressor 503 and subsequently, after mixing together with the vapor stream 502 from the collector 501, to the fan cooler 504 and the separator 505 of the refrigerant fluid thermodynamic refrigeration cycle 500 of the liquefied natural gas production unit. The liquid fraction exits the separator 803 as a liquid stream 808 at a temperature of 17° C., which is partly directed to the heat exchanger 707 of the absorber 701 of the chilled ammonia carbon capture system and then back to the upper part of the separator 803 and partly to a separator at a pressure of 4.5 bar, corresponding with the third separator 812 of the chilled ammonia carbon capture system's refrigerant fluid refrigeration cycle of FIG. 3.

From the collector 501, at a temperature of 12° C., the liquid fraction is suitable to be used to exchange heat with the CO₂ stream 718 from the top of the CO₂ wash column 716 of the chilled ammonia carbon capture system in the heat exchanger 719. Part of the liquid fraction of the collector 50l is therefore directed, as a liquid ammonia stream 821, to a separator 809, at a pressure of 6.5 bar, wherein the refrigerant fluid separates into a liquid fraction and a vapor fraction at a temperature of 12° C. The vapor fraction of the separator 809 is directed as a vapor stream 810 to the compressor 503 and subsequently, after mixing together with the vapor stream 502 from the collector 501 and with the vapor stream 804 from the separator 803, to the fan cooler 504 and to the separator 505 of the refrigerant fluid thermodynamic refrigeration cycle 500 of the liquefied natural gas production unit. The liquid fraction of the separator 809 is directed to the heat exchanger 719 of the CO₂ stream 718 from the top of the CO₂ wash column 716 of the chilled ammonia carbon capture system and then back to the upper part of the separator 809.

The separator 812, receiving the liquid stream 808 from the separator 803 operates at a pressure of 4.5 bar, under which pressure the refrigerant fluid separates into a liquid fraction and a vapor fraction at a temperature of 2° C. The vapor fraction is directed as a vapor stream 813 to the compressor 518, and subsequently, after mixing together with the vapor stream 517 from the collector 516 of the refrigerant fluid thermodynamic refrigeration cycle 500 of the liquefied natural gas production unit and cooling in the heat exchanger 519, to the collector 501. The liquid fraction exits the separator 812 as a liquid stream 815 at a temperature of 2° C., and is directed to the heat exchangers 607, 708, 735 of the chilled ammonia carbon capture system of FIG. 2 and then back to the upper part of the separator 812.

Finally, the liquid fraction of the collector 516 of the refrigerant fluid thermodynamic refrigeration cycle 500 of the liquefied natural gas production unit, at a pressure of 2.6 bar and a temperature of −11° C., can be further expanded to cool down and be used to exchange heat with the CO₂ stream 718 from the top of the CO₂ wash column 716 of the chilled ammonia carbon capture system of FIG. 2, downstream the drier 720, in the heat exchanger 721. Part of the liquid fraction of the collector 516 is therefore directed, as a liquid ammonia stream 822, to a separator 816, at a pressure of 1.8 bar, wherein the refrigerant fluid separates into a liquid fraction and a vapor fraction at a temperature of −25° C. The vapor fraction is directed as a vapor stream 817 to a compressor 818, then to the compressor 518 and subsequently, after mixing together with the vapor stream 517 from the collector 516 of the refrigerant fluid thermodynamic refrigeration cycle 500 of the liquefied natural gas production unit and the vapor stream 813 from the separator 812 of the refrigerant fluid thermodynamic refrigeration cycle of the chilled ammonia carbon capture system and after cooling in the heat exchanger 519, to the collector 501. The liquid fraction exits the separator 816 as a liquid stream 819 at a temperature of −25° C., and is directed to the heat exchanger 721 of the CO₂ stream downstream the drier 720 of the chilled ammonia carbon capture system of FIG. 2 and then back to the upper part of the separator 816.

According to the exemplary embodiment of FIG. 4, the combination of the refrigerant fluid thermodynamic refrigeration cycle of a chilled ammonia carbon capture system with a refrigerant fluid thermodynamic refrigeration cycle of a liquefied natural gas production unit allows for the reduction of the overall number of apparatuses and in particular the overall number of compressors. In fact, by using the same refrigerant fluid both for the refrigerant fluid thermodynamic refrigeration cycle of the chilled ammonia carbon capture system and for the refrigerant fluid thermodynamic refrigeration cycle of the liquefied natural gas production unit, two of the compressors of the refrigerant fluid thermodynamic refrigeration cycle of the chilled ammonia carbon capture system can replace (or can be replaced by) the compressors 503, 518 of the refrigerant fluid thermodynamic refrigeration cycle of the liquefied natural gas production unit. Additionally, a common collector/separator 505 can be used, thus removing the need for a specific collector 801 and related fan cooler 807 of the refrigerant fluid thermodynamic refrigeration cycle of the chilled ammonia carbon capture system.

The operating conditions of both refrigerant fluid thermodynamic refrigeration cycles are the same if the two cycles are integrated or if they are separate. Only a slight change in the operating conditions of the separator 508 is needed.

Finally, in the refrigeration technology of the exemplary embodiment referred to in FIG. 4, the refrigerant fluid is ammonia, and in particular anhydrous ammonia, however, the same refrigeration technology applies in case a different refrigerant fluid is used, such as for example propylene or propane.

While aspects of the invention have been described in terms of various specific embodiments, it will be apparent to those of ordinary skill in the art that many modifications, changes, and omissions are possible without departing form the spirit and scope of the claims.

1. A liquefied natural gas production plant comprising:
a natural gas cooling unit comprising at least one heat exchanger configured to cool a natural gas stream through heating of a refrigerant fluid and also comprising a closed thermodynamic refrigerant fluid refrigeration cycle, configured to cool the heated refrigerant fluid through cyclic thermodynamic transformations, including compression, cooling, condensation, expansion and vaporization;
a carbon capture unit comprising at least one absorber and one desorber, the absorber being configured to absorb carbon dioxide from a flue gas stream through absorption in a solvent stream and the desorber being configured to separate a carbon dioxide rich gas stream from the solvent stream and comprising heating the solvent stream, the carbon capture unit additionally comprising a carbon capture cooling unit comprising heat exchangers configured to cool down the solvent from the desorber, the flue gas and the carbon dioxide rich gas stream through heating of a refrigerant fluid and also comprising a closed thermodynamic refrigerant fluid refrigeration cycle, configured to cool the heated refrigerant fluid through cyclic thermodynamic transformations, including compression, cooling, condensation, expansion and vaporization;
wherein the natural gas cooling unit and the carbon capture cooling unit are integrated by sharing at least part of the apparatuses and the same refrigerant fluid.

2. The liquefied natural gas production plant of claim 1, wherein at least one of the compressors of the natural gas refrigerant fluid refrigeration cycle is also one of the compressors of the carbon capture unit refrigerant fluid refrigeration cycle.

3. The liquefied natural gas production plant of claim 1, wherein the solvent of the carbon capture unit is ammonia.

4. The liquefied natural gas production plant of claim 1, wherein the refrigerant fluid is chosen among ammonia, propylene or propane.

5. The liquefied natural gas production plant of claim 1, wherein the refrigerant fluid is chosen amongst hydrocarbons containing 2, 3, 4 or 5 carbon atoms per molecule, or mixtures thereof.

6. The liquefied natural gas production plant of claim 1, wherein the carbon capture unit is configured to treat flue gas from the compressors of the natural gas refrigerant fluid refrigeration cycle.

7. The liquefied natural gas production plant of claim 1, wherein a second natural gas cooling unit is comprised, the second natural gas cooling unit comprising a plurality of heat exchangers configured to cool the natural gas stream downstream the first natural gas cooling unit through heating of a second refrigerant fluid and also comprising a closed thermodynamic second refrigerant fluid refrigeration cycle, configured to cool the heated second refrigerant fluid through cyclic thermodynamic transformations, including compression, cooling, condensation, expansion and vaporization.

8. The liquefied natural gas production plant of claim 7, wherein the first refrigerant fluid is also used to exchange heat with the second refrigerant fluid in the closed thermodynamic second refrigerant fluid refrigeration cycle.

9. The liquefied natural gas production plant of claim 7, wherein the carbon capture unit is configured to treat flue gas from the compressors of the natural gas second refrigerant fluid refrigeration cycle.
